(19) United States
(12) Patent Application Publication
(10) Pub. No.: US 2024/0107618 A1
(43) Pub. Date: Mar. 28, 2024

(54) INFORMATION TRANSMISSION METHOD AND APPARATUS, AND STORAGE MEDIUM

(71) Applicant: VIVO MOBILE COMMUNICATION CO., LTD., Dongguan (CN)

(72) Inventors: Siqi LIU, Dongguan (CN); Zichao JI, Dongguan (CN); Shuyan PENG, Dongguan (CN)

(73) Assignee: VIVO MOBILE COMMUNICATION CO., LTD., Dongguan (CN)

(21) Appl. No.: 18/536,198

(22) Filed: Dec. 11, 2023

Related U.S. Application Data
(63) Continuation of application No. PCT/CN2022/101426, filed on Jun. 27, 2022.

(30) Foreign Application Priority Data
Jun. 28, 2021 (CN) 202110723367.6

(51) Int. Cl. H04W 76/20; H04L 5/00; H04W 72/12

(52) U.S. Cl. CPC H04W 76/20; H04L 5/0053; H04W 72/12; H04W 92/18

(57) ABSTRACT

An information transmission method and apparatus, and a storage medium, are provided. The information transmission method includes: determining, by a terminal, state information corresponding to a sidelink resource on an unlicensed frequency band; and sending, by the terminal, the state information to a target node, where the target node includes a control node or a target terminal.

### CROSS-REFERENCE TO RELATED APPLICATIONS

This application is a continuation of International Application No. PCT/CN2022/101426, filed on Jun. 27, 2022, which claims priority to Chinese Patent Application No. 202110723367.6, filed Jun. 28, 2021. The entire contents of each of the above-identified applications are expressly incorporated herein by reference.

### TECHNICAL FIELD

This application pertains to the field of communications technologies, and in particular, to an information transmission method and apparatus, and a storage medium.

### BACKGROUND

To obtain more resources to meet a service requirement of SideLink (SL) transmission, SL transmission may need to be performed in an unlicensed frequency band.

However, the current SL technical framework is mostly designed for a licensed frequency band or an SL dedicated frequency band. On the unlicensed frequency band, there may be other wireless technologies, such as WiFi, so user equipment needs to sense whether the resource is idle firstly, and attempts to initiate channel access when it is determined that the resource is idle. In a case that there is a control node, a sensing result by the user may need to be informed to the control node to help the control node determine an appropriate scheduling strategy. Otherwise, the user may not preempt the resource, but the control node schedules for the user or asks the user for feedback, resulting in the waste of the resource.

### SUMMARY

Embodiments of this application provide an information transmission method and apparatus, and a storage medium.

According to a first aspect, an information transmission method is provided, including:
determining, by a terminal, state information corresponding to a sidelink resource on an unlicensed frequency band; and
sending, by the terminal, the state information to a target node, where the target node includes a control node and/or a target terminal.

According to a second aspect, an information transmission method is provided, including:
obtaining, by a target node, state information, where the state information is sent to the target node after a terminal determines state information corresponding to a sidelink resource on an unlicensed frequency band; and the target node includes a control node and/or a target terminal.

According to a third aspect, an information transmission apparatus is provided, including:
a first determining module, configured to determine state information corresponding to a sidelink resource on an unlicensed frequency band; and
a first indication module, configured to send the state information to a target node, where the target node includes a control node and/or a target terminal.

According to a fourth aspect, an information transmission apparatus is provided, including:
a third obtaining module, configured to obtain state information, where the state information is sent to the target node after a terminal determines state information corresponding to a sidelink resource on an unlicensed frequency band; and the target node includes a control node and/or a target terminal.

According to a fifth aspect, a terminal is provided, where the terminal includes a processor, a memory, and a program or an instruction stored in the memory and executable on the processor, and when the program or the instruction is executed by the processor, steps of the method according to the first aspect are implemented.

According to a sixth aspect, a terminal is provided, including a processor and a communications interface, where the processor is configured to: determine state information corresponding to a sidelink resource on an unlicensed frequency band; and send the state information to a target node, where the target node includes a control node and/or a target terminal.

According to a seventh aspect, a network side device is provided, where the network side device includes a processor, a memory, and a program or an instruction stored in the memory and executable on the processor, and when the program or the instruction is executed by the processor, steps of the method according to the first aspect are implemented.

According to an eighth aspect, a network side device is provided, including a processor and a communications interface, where the processor is configured to obtain state information; the state information is sent to the target node after a terminal determines state information corresponding to a sidelink resource on an unlicensed frequency band; and the target node includes a control node and/or a target terminal.

According to a ninth aspect, a readable storage medium is provided, where the readable storage medium stores a program or an instruction, and when the program or the instruction is executed by a processor, steps of the method according to the first aspect or the steps of the method according to the second aspect are implemented.

According to a tenth aspect, a chip is provided, where the chip includes a processor and a communications interface, the communications interface is coupled to the processor, and the processor is configured to run a program or an instruction to implement the method according to the first aspect or the method according to the second aspect.

According to an eleventh aspect, a computer program/program product is provided, where the computer program/program product is stored in a storage medium, and the program/program product is executed by at least one processor to implement steps of the method according to the first aspect, or steps of the method according to the second aspect.

In this embodiment of this application, by determining the state information corresponding to the sidelink resource of the unlicensed frequency band and sending the state information, the control node and the terminal are guaranteed to understand the same, and the resource utilization rate is improved.

### BRIEF DESCRIPTION OF DRAWINGS

FIG. 1 is a structural diagram of a wireless communications system according to an embodiment of this application;

FIG. 2 is a first flowchart of an information transmission method according to an embodiment of this application;

FIG. 3 is a second flowchart of an information transmission method according to an embodiment of this application;

FIG. 4 is a first block diagram of a structure of an information transmission apparatus according to an embodiment of this application;

FIG. 5 is a second block diagram of a structure of an information transmission apparatus according to an embodiment of this application;

FIG. 6 is a block diagram of a structure of a communications device according to an embodiment of this application;

FIG. 7 is a block diagram of a hardware structure of a terminal according to an embodiment of this application; and

FIG. 8 is a block diagram of a hardware structure of a network side device according to an embodiment of this application.

### DETAILED DESCRIPTION

The following describes the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first,” “second,” and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. A New Radio (NR) system is described below as an example, and the term NR is used in most of the descriptions, but these technologies can also be used in an application other than an application of the NR system, for example, a 6^{th} Generation (6G) communications system.

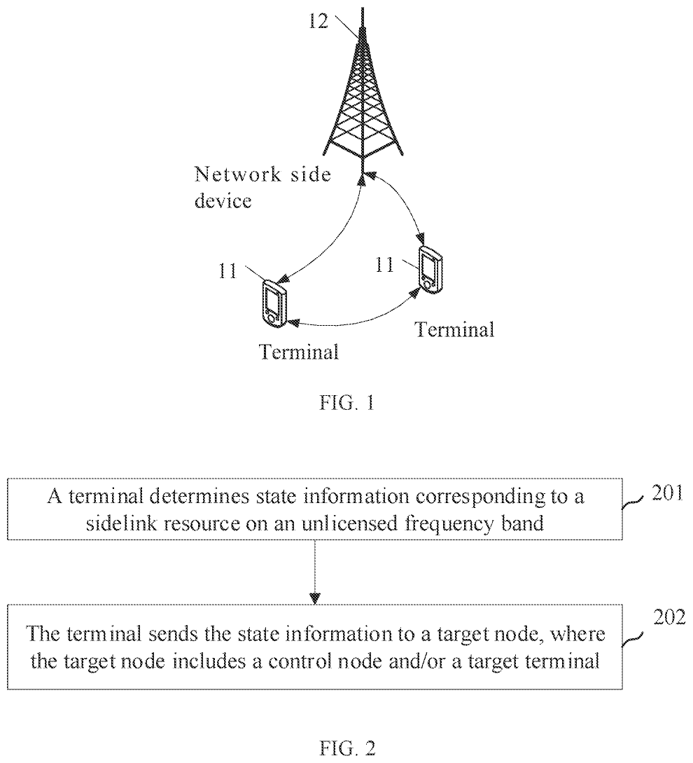

FIG. 1 is a structural diagram of a wireless communications system to which embodiments of this application can be applied. The wireless communication system includes a terminal 11 and a network side device 12. The terminal 11 may also be referred to as a terminal device or User Equipment (UE). The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (household devices with wireless communications functions, such as a refrigerator, a television, a washing machine, or furniture), and the wearable device include a smart watch, a smart band, a smart headphone, smart glasses, smart jewelry (a smart bracelet, a smart hand chain, a smart ring, a smart necklace, a smart bangle, a smart anklet, or the like), a smart wristband, smart clothes, a game console, and the like. It should be noted that a specific type of the terminal 11 is not limited in the embodiments of this application. The network side device 12 may be a base station or a core network. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

The following describes in detail the information transmission method and apparatus, and a storage medium provided in the embodiments of this application through some embodiments and application scenarios thereof with reference to the accompanying drawings.

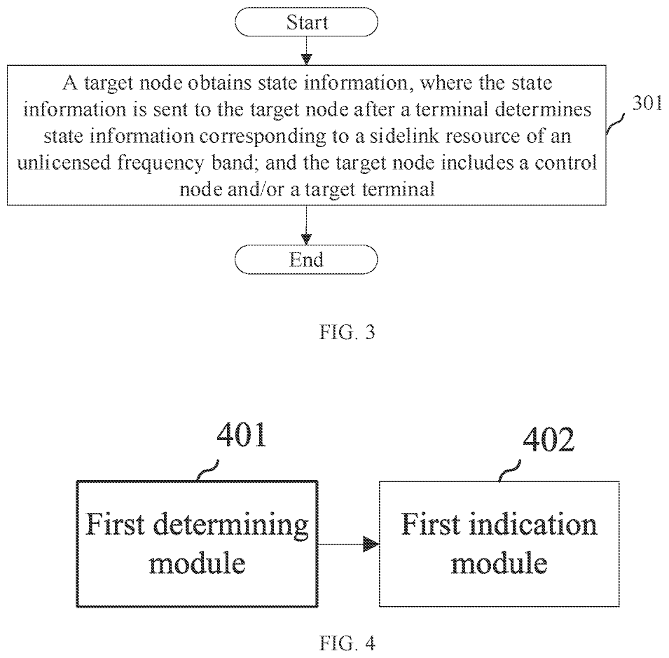

FIG. 2 is a first schematic flowchart of an information transmission method according to an embodiment of this application. As shown in FIG. 2, this embodiment of this application discloses an information transmission method, and an execution subject can be UE, for example, first user equipment UE 1 or second user equipment UE 2, and the method includes the following steps.

Step 201. A terminal determines state information corresponding to a sidelink resource on an unlicensed frequency band.

Step 202. The terminal sends the state information to a target node, where the target node includes a control node and/or a target terminal.

One way to determine the state information corresponding to the sidelink resource of the unlicensed frequency band is to sense the sidelink resource to determine the corresponding state information.

In some implementations, a network architecture involved in the information transmission method of this embodiment of this application includes at least a control node, UE 1, and UE 2.

Transmission of a SideLink (SL) packet may be performed on an SL between the UE 1 and the UE 2.

A device with scheduling capability or control capability is referred to as a control node, which can be at least one of a base station (such as an NR base station, an LTE base station, or the like), a Road Side Unit (RSU), scheduling UE, header UE, a vehicle head, and the like.

The target node in this embodiment of this application includes a control node and/or a target terminal, and the target terminal is a terminal associated with SL transmission of the terminal. For example, when the terminal is the UE 1, the target terminal is the UE 2; and when the terminal is the UE 2, the target terminal is the UE 1.

This embodiment of this application can be applied to at least one of the following scenarios.

Scenario 1. The control node indicates a sidelink resource to the UE 1, and the UE 1 sends state information to the control node and/or third user equipment UE 3.

Case 1. The control node indicates the sidelink resource to the UE 1, the UE 1 senses the sidelink resource and determines state information, and the UE 1 sends the state information to the control node.

Case 2. The control node indicates the sidelink resource to the UE 1, the UE 1 indicates the sidelink resource to the UE 2, the UE 2 senses the sidelink resource and determines state information, the UE 2 sends the state information to the UE 1, and the UE 1 sends the state information to the control node.

Scenario 2. The control node indicates the sidelink resource to the UE 1, and the UE 2 sends the state information to the control node and/or the UE 3.

Case 1. The control node indicates the sidelink resource to the UE 1, the UE 1 indicates the sidelink resource to the UE 2, the UE 2 senses the sidelink resource and determines the state information, and the UE 2 sends the state information to the control node.

Case 2. The control node indicates the sidelink resource to the UE 1, the UE 1 senses the sidelink resource and determines state information, the UE 1 sends the state information to the UE 2, and the UE 2 sends the state information to the control node.

Scenario 3. The UE 1 instructs the UE 2 to sense the sidelink resource, and the UE 2 determines the state information and sends the state information to the UE 1.

In some implementations, the sidelink resource includes at least one of the following:
a target channel;
target transmission;
a target beam; and
a target time.
a. In some implementations, the time may be interpreted as at least one of the following: one period;
a Channel Occupancy Time (COT);
timer running duration; and
Extended Clear Channel Assessment (eCCA).
b. In some implementations, the sidelink resource may be at least one of the following:
a resource for transmitting a PSCCH and/or a PSSCH;
a COT for transmitting a PSCCH and/or a PSSCH;
a resource including a PSCCH and/or a PSSCH; and
a COT including a PSCCH and/or a PSSCH.
c. In some implementations, the sidelink resource may be at least one of the following:
a resource for transmitting a PSCCH and/or a PSSCH and a related PSFCH;
a COT for transmitting a PSCCH and/or a PSSCH and a related PSFCH;
a resource including a PSCCH and/or a PSSCH and a related PSFCH; and
a COT including a PSCCH and/or a PSSCH and a related PSFCH.

The target transmission may be transmitting data, control information, and some special signals, such as a preamble.

The sidelink resource includes a first sidelink resource and a second sidelink resource.

The first sidelink resource includes at least one of the following:
a first channel;
first transmission;
a first beam; and
a first time.

The second sidelink resource includes at least one of the following:
a second channel;
second transmission;
a second beam; and
a second time.

In some implementations, the following is further included:
obtaining first indication information, where
the first indication information is used to indicate at least one of the following:
the sidelink resource; and
a listening parameter of the sidelink resource; and
sensing the sidelink resource.

In some implementations, before this, the control node indicates the sidelink resource of the UE 1, or instructs the UE 1 to sense the sidelink resource.
a. For example, the control node sends information about the sidelink resource to the UE 1, and the UE 1 senses the sidelink resource.
b. In some implementations, the control node sends sensing configuration information to the UE 1, and the UE 1 performs sensing based on the sensing configuration information, where the sensing configuration information includes at least one of the following.
i. Type of the sidelink resource, for example, a specific channel type, such as S-SSB, PSSCH, PSSCH, and PSFCH.
ii. At least one of a maximum number of preemption attempts, a preemption time (for example, it is considered as a failure if it exceeds a time limit), indication of a preempted beam (for example, which beam or beams are used for preemption), a starting time of preemption, duration of preemption, information about a sensed sidelink resource (for example, sensing a preset channel, preset signaling, and a preset sequence), information about a signal and/or a channel used to preempt a resource or indicate that a resource has been preempted (for example, using a specific channel, specific signaling, a specific sequence, such as using a specific structure on a specific resource), a preempted resource structure (for example, an interlace or a pattern of the preempted resource), and the like.

In some implementations, the state information includes at least one of the following:
first state information corresponding to a first sidelink resource, where the first sidelink resource is at least part of the sidelink resource; and
second state information corresponding to a second sidelink resource, where the second sidelink resource is at least part of the sidelink resource.
i. The first state information is used to indicate at least one of the following:
1. the first sidelink resource is available;
2. the first sidelink resource is available to another terminal; and the another terminal is a terminal other than the terminal;
for example, a right to use the first sidelink resource is obtained (or the first sidelink resource can be used);
preemption and/or channel access on the first sidelink resource is successful;
3. the first sidelink resource is idle;
4. the first sidelink resource is idle for another terminal;
5. transmission or reception on the first sidelink resource is successful;
6. ACKnowledgement (ACK);
for example, the UE succeeds in preempting and/or channel access on the resource, and feeds ACK back to the control node; and
7. feedback information and/or an SL decoding state;
for example, SL Hybrid Automatic Repeat reQuest ACKnowledgement (HARQ-ACK) information obtained by the UE or information on the Physical Sidelink Feedback CHannel (PSFCH), or HARQ-ACK information determined or generated based on PSFCH reception.

In some implementation methods, at least one of the foregoing items can be indicated by setting the content of the first state information as preset content, and the preset content can be a bit string indicating some specific meanings, for example, the content of the first state information is 1100, and 1100 indicates that the resource preemption is successful.
ii. The second state information is used to indicate at least one of the following:
1. the second sidelink resource is unavailable;
2. the second sidelink resource is unavailable to another terminal;
   for example, a right to use the second sidelink resource is not obtained (or the second sidelink resource cannot be used);
preemption and/or channel access on the second sidelink resource fails;
3. the second sidelink resource is busy;
4. the second sidelink resource is busy for another terminal;
5. transmission or reception on the second sidelink resource fails;
6. no transmission or reception on the second sidelink resource and/or no feedback (namely, Discontinuous Transmission (DTX)) corresponding to transmission or reception on the second sidelink resource is detected;
7. transmission or reception on the second sidelink resource and/or the feedback corresponding to transmission or reception on the second sidelink resource is canceled;
8. Negative ACKnowledgement (NACK);
for example, the UE fails in preemption and/or channel access on the resource, NACK is fed back to the control node, and further, the control node may instruct the UE to sense a new sidelink resource; and
9. feedback information/an SL decoding state;
for example, the UE 2 indicates both the SL decoding state and whether the UE 2 has successfully obtained the channel of the PSFCH for the control node. If the decoding is successful, the control node does not need to schedule retransmission even if the UE 2 does not successfully obtain the PSFCH.

In some implementation methods, at least one of the foregoing items can be indicated by setting the content of the second state information as preset content, for example, the preset content is a bit string indicating a specific meaning, for example, the content of the second state information is 0000, and 0000 indicates that preemption of the resource fails.

In some implementations, the second sidelink resource meets at least one of the following conditions:
each second sidelink resource has at least one associated resource for indicating the second state information;
an N1^{th} second sidelink resource of the second sidelink resource or an M1^{th} second sidelink resource of at least part of the second sidelink resource has at least one associated resource for indicating the second state information; and
N2 second sidelink resources of the second sidelink resource or M2 second sidelink resources of at least part of the second sidelink resource has at least one associated preamble resource for indicating the second sidelink resource, where N1, N2, M1, and M2 are all positive integers.

In some implementations, in a case that the UE 1 cannot determine the second state information, that is, cannot judge whether the second resource is idle and/or available (usually this case means that the second resource is sensed by the UE 2), the design of the second resource includes at least one of the following (usually not using Frame Based Equipment (FBE) scenarios):
locations of a plurality of second sidelink resources are determined by at least one of the following manners:
being configured by a control node;
being preconfigured;
being predefined; and
being obtained by UE.

The UE senses at least part of them.
1. Each second sidelink resource has at least one associated resource for explicitly or implicitly indicating the second state information.

For example, each second sidelink resource has one associated resource for explicitly or implicitly indicating the second state information.
2. An N1^{th} of a plurality of second sidelink resources or an M2^{th} second resource of the at least part of the second resource has at least one associated resource for explicitly or implicitly indicating the second state information.

For example, a last of a plurality of second sidelink resources or a last second resource of the at least part of the second resource has at least one associated resource for explicitly or implicitly indicating the second state information.

3. An N1^{th} of a plurality of second sidelink resources or an M2^{th} second resource of the at least part of the second resource (each second resource) has at least one associated preamble resource for indicating the resource.

For example, if the preamble resource is detected, it means that the corresponding second resource is idle and/or available, or has been successfully preempted.

In some implementations, the state information includes at least one of the following.
1. State information corresponding to any or all types of sidelink resources.

For example, the target channel may include a plurality of types of channels, but one piece of state information is reported to the channels.
2. State information corresponding to each of different types of sidelink resources.

For example, the target channel may include a plurality of types of channels, and each state information thereof is reported, for example, each of the Physical Sidelink Shared CHannel (PSSCH) and the PSFCH has state information thereof.

Where:
1. The first sidelink resource and/or the second sidelink resource is at least part of the sidelink resource.

For example, the first sidelink resource is the sidelink resource.

For another example, the second sidelink resource is the sidelink resource.
2. In some implementations, the first sidelink resource and/or the second sidelink resource are preset sidelink resources associated with the sidelink resource.

For example, the target resource is the PSSCH and/or the Physical Sidelink Control CHannel (PSCCH), and the first sidelink resource and/or the second sidelink resource is a related PSFCH.

3. The UE 2 is receiving UE of the UE 1 or sending UE of the UE 1, or the UE 2 is transmission-related UE of the UE 1.

In some implementations, the UE 1 and/or the UE 2 send/sends the state information to the target node in an explicit or implicit manner.
a. When at least one of the following conditions is met, it is sent to the control node in an explicit or implicit manner.
i. The control node configures a semi-static resource for the transmission of the state information, for example, UpLink (UL) Configured Grant (CG).
ii. The control node schedules the UE to transmit the state information.
iii. At least part of the sidelink resource is idle, at least part of the sidelink resource is available, at least part of the sidelink resource is idle for another terminal, at least part of the sidelink resource is available to another terminal, transmission or reception is performed on at least part of the sidelink resource, transmission or reception on at least part of the sidelink resource is successful, and the UE obtains at least one of ACK.

That at least part of the sidelink resource is available, or at least part of the sidelink resource is available to another terminal includes at least one of the following:
obtaining a right to use at least part of the sidelink resource;
successfully preempting at least part of the sidelink resource; and the channel successfully accessing at least part of the sidelink resource.
iv. Transmission or reception on at least part of the sidelink resource is decoded successfully.
v. Feedback information corresponding to transmission or reception on at least part of the sidelink resource is ACK.
vi. The state information includes first state information.
b. Not being sent to the control node when at least one of the following conditions is met.
i. At least part of the sidelink resource is busy and/or unavailable, the right to use at least part of the sidelink resource is not obtained, fails in preemption and/or channel access to at least part of the sidelink resource, transmission or reception on at least part of the sidelink resource fails or DTX, no feedback (such as DTX) corresponding to at least part of the sidelink resource is detected, and the UE obtains at least one of NACK and the like.
ii. The state information includes only second state information.

In some implementations, the UE 1 and/or the UE 2 may send the state information to the control node in an explicit or implicit manner.

A step of indicating the state information to another node includes:
sending the first state information to the control node, where the sending the first state information to the control node includes at least one of the following.
a. A specific method of sending the first state information to the control node in an explicit or implicit manner includes at least one of the following:
i. sending the first state information; and
ii. not sending state information, for example, not sending the second state information indicates that the first state information is sent, for example, DTX is used to indicate the state information.
b. A step of indicating the state information to another node includes:
sending the second state information to the control node, where the sending the second state information to the control node includes at least one of the following:
i. sending the second state information; and
ii. not sending state information, for example, not sending the first state information, namely, DTX is used to indicate the state information.

In some implementations, the UE 1 and/or the UE 2 send/sends the first state information to the control node in a preset condition 1, and the preset condition 1 includes at least one of the following.
a. It is sensed that at least part of the sidelink resource is available.
b. At least part of the sidelink resource is available to another terminal.

For example, a right to use at least part of the sidelink resource is obtained (or the first sidelink resource can be used).

Preemption and/or channel access to at least part of the sidelink resource is successful.
c. At least part of a sidelink resource is idle.
d. At least part of the sidelink resource is idle for another terminal.
e. Transmission or reception is performed on at least part of the sidelink resource.
f. Transmission or reception performed on at least part of the sidelink resource is successful.

In some implementations, the UE 1 and/or the UE 2 send/sends the second state information to the control node in a preset condition 2, and the preset condition 2 includes at least one of the following.
a. It is sensed that at least part of the sidelink resource is unavailable.
b. At least part of the sidelink resource is unavailable to another terminal.

For example, a right to use at least part of the sidelink resource is not obtained (or the first sidelink resource can be used).

Preemption and/or channel access to at least part of the sidelink resource fails.
c. At least part of the sidelink resource is busy.
d. At least part of the sidelink resource is busy for another terminal.
e. At least part of the sidelink resource is not used for transmission or reception.
f. Transmission or reception performed on at least part of the sidelink resource fails.
g. For a case that the second state information is sent by the first terminal (including at least one of the terminal and a terminal associated with SL transmission of the terminal, for example, the terminal is the UE 1 and the terminal UE 2 associated with the UE 1, and the first terminal includes the UE 1 and/or the UE 2), the preset condition 2 may include one condition, that is, the first terminal does not receive an expected feedback.

For example, the UE 2 does not obtain the resource of the PSFCH, so the UE 1 cannot detect the PSFCH fed back by the UE 2. In this case, the UE 1 indicates that the second state information of the control node indicates that the PSFCH resource is busy and/or unavailable.
h. In a case that the second state information is sent by the first terminal, the preset condition 1 may include one condition, that is, the feedback received by the first terminal is NACK.

For example, the UE 2 obtains the resource of the PSFCH, but cannot decode the PSCCH and/or the PSSCH, and reports NACK to the UE 1 through the PSFCH, so that the UE 1 indicates that the second state information of the control node indicates that transmission of the PSCCH and/or the PSSCH fails.

In some implementations, the UE obtains a reporting resource and/or the control node provides a state information configuration, and how to indicate the state information is determined based on the state information configuration. The state information configuration specifically includes at least one of the following.
a. Information about a reporting resource for indicating state information.

The UE obtains a reporting resource and/or the control node provides a reporting resource, and the UE sends the state information on the reporting resource in an explicit or implicit manner.

In some implementations, for the reporting resource, the state information meets at least one of the following.
i. Different types of state information are corresponding to different reporting resources.

For example, the first state information is corresponding to a first reporting resource, and the second state information is corresponding to a second reporting resource.

In some implementations, if the second state information is transmitted, the first state information is released for a period of time/permanently corresponding to different reporting resources, or vice versa.
ii. Pieces of state information with different content are corresponding to different reporting resources.

For example, state information related to preemption is corresponding to the first reporting resource, state information related to feedback information is corresponding to the second reporting resource, state information related to an SL decoding state is corresponding to a third reporting resource, state information related to ACK is corresponding to a fourth reporting resource, and state information related to NACK is corresponding to a fifth reporting resource.

In some implementations, if related state information is preempted and/or obtained, and the preemption and/or obtaining fails, at least one of the following is released for a period of time and/or permanently:
a reporting resource corresponding to the state information related to the feedback information;
a reporting resource corresponding to state information related to an SL decoding state;
a reporting resource corresponding to state information related to ACK; and
a reporting resource corresponding to state information related to NACK.
iii. Pieces of state information corresponding to different sidelink resources are corresponding to different reporting resources.
iv. Pieces of state information corresponding to different types of sidelink resources are corresponding to different reporting resources.

For example, state information of the PSSCH is corresponding to the first reporting resource, and state information of the PSFCH is corresponding to the second reporting resource.

The reporting resource is a resource for indicating the state information.
b. A state information reporting manner.
i. Report state information for different types of sidelink resources, or report state information uniformly.

That is, report the state information separately for different types of channel-sidelink resources, or report one piece of state information uniformly.
ii. Report based on a state information type.

That is, only the first state information is reported, or only the second state information is reported, or both the first state information and the second state information can be reported.
c. State information content.

For example, state information of what content can be reported. The content of the reported state information includes at least one of the following:
state information related to preemption;
state information related to feedback information;
state information related to an SL decoding state;
state information related to ACK; and
state information related to NACK.

In this embodiment of this application, by determining the state information corresponding to the sidelink resource of the unlicensed frequency band and sending the state information, the control node and the terminal are guaranteed to understand the same, and the resource utilization rate is improved.

FIG. 3 is a second schematic flowchart of an information transmission method according to an embodiment of this application. As shown in FIG. 3, this embodiment of this application provides an information transmission method, and an execution subject is a target node, for example, a control node, and the method includes:
obtaining, by a target node, state information, where the state information is sent to the target node after a terminal determines state information corresponding to a sidelink resource on an unlicensed frequency band; and the target node includes a control node and/or a target terminal.

Sensing the sidelink resource of the unlicensed frequency band can be performed by the UE 1 or the UE 2. Sending the state information to the control node can be performed by the UE 1, the UE 2, or the UE 3. For details, refer to the description of the application scenarios in the foregoing embodiment. Details are not described herein again.

The control node may obtain the state information in an explicit manner, for example, directly receiving the state information sent by target user equipment.

The control node may also obtain the state information in an implicit manner, for example, the control node allocates a reporting resource for the user equipment, and if the control node does not detect relevant content on the reporting resource, it means that the user equipment is successful, that is, the control node obtains the state information in the implicit manner.
a. If the first state information is obtained, the control node determines at least one of the following.
i. At least part of a first sidelink resource is available.
ii. At least part of the first sidelink resource is available to another terminal.

For example, (UE) obtains a right to use at least part of the sidelink resource (or the first sidelink resource can be used).

Preemption and/or channel access to at least part of the first sidelink resource (performed by UE) is successful.
iii. At least part of a first sidelink resource is idle.
iv. At least part of the first sidelink resource is idle for another terminal.
v. Transmission or reception performed on at least part of the first sidelink resource is successful.
vi. Determine whether the first sidelink resource is idle and/or available based on the feedback information, or determine at least one of the following of the first sidelink resource:
obtaining succeeds or fails;
preemption succeeds or fails;
channel access succeeds or fails; and
transmission succeeds or fails.

For example, if the first state information is information on SL HARQ-ACK or PSFCH, success or failure is determined based on this information.
b. If the second state information is obtained, the control node determines at least one of the following.
i. At least part of a second sidelink resource is unavailable.
ii. At least part of the second sidelink resource is unavailable to another terminal.
For example, (UE) does not obtain a right to use at least part of the second sidelink resource (or the second sidelink resource cannot be used).

Preemption and/or channel access to at least part of the second sidelink resource (performed by UE) fails.
iii. At least part of a second sidelink resource is busy.
iv. At least part of the second sidelink resource is busy for another terminal.
v. Transmission or reception performed on at least part of the second sidelink resource fails or at least part of the second sidelink resource is not used for transmission or reception.

For at least one of i to v, it also includes that the control node may continue to indicate a new sidelink resource to the UE.
a. In some implementations, behind the second state information, a new sidelink resource is sent to the first terminal after a time 1.

The time 1 includes a processing time of the second state information and/or the time indicating the new sidelink resource, and the time 1 includes at least one of the following:
one or more slots;
one or more symbols;
one or more subframes;
one or more frames; and
one or more periods.
b. In some implementations, a new sidelink resource is sent to the first terminal in a time 2 before a reporting resource of the second state information.

The time 2 includes a processing time of the second state information and/or the time indicating the new sidelink resource, and the time 2 includes at least one of the following:
one or more slots;
one or more symbols;
one or more subframes;
one or more frames; and
one or more periods.

In some implementations, if the first state information is further obtained and/or the second state information is not obtained, the control node and/or the UE considers the new sidelink resource invalid and/or discarded, that is, the UE does not need to sense the new sidelink resource.

In some implementations, it should be further noted that:
a. Whether the sidelink resource mentioned in the foregoing embodiment is idle and/or available and/or busy and/or unavailable refers to the following cases.
i. Whether the sidelink resource is idle and/or available and/or busy and/or unavailable to SL transmission thereof (for example, although it is detected that the sidelink resource has been occupied by the SL system or another SLUE, the UE thinks that it is available to SL transmission thereof and can directly perform SL transmission).
ii. In some implementations, whether the sidelink resource is idle and/or available and/or busy and/or unavailable to the SL system (for example, if it is detected that the sidelink resource is not used by any UE, the sidelink resource may be used by the UE and/or another UE in the SL system).
iii. In some implementations, whether the sidelink resource is idle and/or available and/or busy and/or unavailable to any system (for example, an Uu system and/or the SL system) (for example, if it is detected that the sidelink resource is not used by any UE, the sidelink resource may be used by the UE and/or another UE in the SL system and/or the Uu system).
b. The mentioned obtaining or not obtaining the right to use the sidelink resource refers to the following cases.
i. Obtain or not obtain the right to use the sidelink resource for SL transmission thereof.
ii. In some implementations, obtain or not obtain the right to use the sidelink resource for the SL system.
iii. In some implementations, obtain or not obtain the right to use the sidelink resource for any system (such as the Uu system and/or the SL system).
c. The mentioned that preemption and/or channel access on the sidelink resource is successful or fails refers to the following cases.
i. For SL transmission of the UE.
ii. In some implementations, for the SL system.
iii. In some implementations, for any system (such as the Uu system and/or the SL system).
d. The mentioned that the transmission or reception performed or cannot be performed on the sidelink resource refers to the following cases.
i. For SL transmission of the UE.
ii. In some implementations, for the SL system.
iii. In some implementations, for any system (such as the Uu system and/or the SL system).
e. The mentioned that transmission or reception performed on the sidelink resource is successful or fails refers to the following cases.
i. For SL transmission of the UE.
ii. In some implementations, for the SL system.
iii. In some implementations, for any system (such as the Uu system and/or the SL system).

In some implementations, the resource for explicitly or implicitly indicating the state information includes at least one of the following:
a. PUCCH;
b. PUSCH;
c. PSFCH;
d. PSSCH;
for example, when the control node is UE, the resource indicating the state information is the PSSCH; and
e. PSCCH.

For example, when the control node is UE, the resource indicating the state information is the PSCCH.

In some implementations, a manner of obtaining the resource for explicitly or implicitly indicating the state information includes at least one of the following:
a. being allocated and/or scheduled by the control node;
b. being predefined;
c. being preconfigured;
d. being obtained by UE; and
e. being scheduled by another UE or recommended to the UE.

In some implementations, the control node operates on a licensed frequency band or a non-shared frequency band.

In some implementations, the UE 1 and/or the UE 2 and/or another UE perform transmission or reception on the sidelink resource.

For example, the control node may instruct the UE 1 to sense whether the sidelink resource is idle, and if so, the UE 2 or another UE is scheduled to perform transmission or reception on the sidelink resource.

The following further describes the foregoing embodiment by using several specific examples.

### Example 1: The PSCCH and/or PSSCH Fails and/or is Busy

The control node schedules the node to indicate the PSCCH and/or PSSCH to the UE 1, and the UE 1 senses the PSCCH and/or the sidelink resource corresponding to the PSSCH, and attempts to perform preemption and/or channel access.
a. It is assumed that the sidelink resource preemption and/or channel access fails, or it is sensed that the sidelink resource is busy.

The UE 1 sends the second state information to the control node.
1. In a case, the second control information is NACK.

After receiving NACK, the control node may indicate a new PSCCH and/or PSSCH to the UE 1.
2. In a case, the second control information indicates that the sidelink resource preemption and/or channel access fails.

After receiving the information, the control node may indicate a new PSCCH and/or PSSCH to the UE 1.
b. It is assumed that the sidelink resource preemption and/or channel access fails, or it is sensed that the sidelink resource is busy.

The UE 2 sends the second state information to the control node.
1. For example, if FBE method is used in this case, it can be assumed that sensing results from the UE 1 and the UE 2 are the same. For example, if the UE 1 determines that the sidelink resource channel is busy, the UE 2 may also determine that the sidelink resource channel is busy, so the UE 2 can send the state information.
2. In a case, the second control information is NACK.

After receiving NACK, the control node may indicate a new PSCCH and/or PSSCH to the UE 1.
3. In a case, the second control information indicates that the sidelink resource preemption and/or channel access fails.

After receiving the information, the control node may indicate a new PSCCH and/or PSSCH to the UE 1.

### Example 2: The PSCCH and/or PSSCH is Successful and/or Idle

The control node schedules the node to indicate the PSCCH and/or PSSCH to the UE 1, and the UE 1 senses the PSCCH and/or the sidelink resource corresponding to the PSSCH, and attempts to perform preemption and/or channel access.

It is assumed that the sidelink resource preemption and/or channel access is successful, or it is sensed that the sidelink resource is idle.

The UE 1 sends the second state information to the control node.
1. In a case, the second control information is ACK.
2. In a case, the second control information indicates that the sidelink resource preemption and/or channel access is successful.
3. In a case, the second control information is SL HARQ-ACK information corresponding to the PSCCH and/or PSSCH or information on the corresponding PSFCH.
b. It is assumed that the sidelink resource preemption and/or channel access is successful, or it is sensed that the sidelink resource is idle.

The UE 2 sends the second state information to the control node.
1. For example, if FBE method is used in this case, it can be assumed that sensing results from the UE 1 and the UE 2 are the same. For example, if the UE 1 determines that the sidelink resource is busy, the UE 2 may also determine that the sidelink resource is busy, so the UE 2 can send the state information.
2. In a case, the second control information is ACK.
3. In a case, the second control information indicates that the sidelink resource preemption and/or channel access is successful.
4. In a case, the second control information is SL HARQ-ACK information corresponding to the PSCCH and/or PSSCH or information on the corresponding PSFCH.

If the SL HARQ-ACK information or the information on the PSFCH is NACK, it means that although preemption is successful, the UE 2 does not successfully decode the message. In this case, the UE 2 sends NACK to the control node, and after receiving NACK, the control node can indicate a new PSCCH and/or PSSCH to the UE 1.

### Example 3: The PSCCH and/or PSSCH is Successful and/or Idle, and the PSFCH Fails

The control node schedules the node to indicate the PSCCH and/or PSSCH and/or PSFCH to the UE 1, and the UE 1 senses the sidelink resource corresponding to the PSCCH and/or PSSCH and/or PSFCH, and attempts to perform preemption and/or channel access.

It is assumed that preemption and/or channel access of the sidelink resource corresponding to the PSCCH and/or PSSCH is successful, or it is sensed that the sidelink resource corresponding to the PSCCH and/or PSSCH is idle, however, preemption and/or channel access of the sidelink resource corresponding to the PSFCH fails, or the sidelink resource corresponding to the PSFCH is busy.

The UE 1 sends the second state information to the control node.
1. In a case, the second control information is NACK.
2. In a case, the second control information indicates that preemption and/or channel access of the sidelink resource corresponding to the PSFCH fails.
b. It is assumed that preemption and/or channel access of the sidelink resource corresponding to the PSCCH and/or PSSCH is successful, or it is sensed that the sidelink resource corresponding to the PSCCH and/or PSSCH is idle, however, preemption and/or channel access of the sidelink resource corresponding to the PSFCH fails, or the sidelink resource corresponding to the PSFCH is busy.

The UE 2 sends the second state information to the control node.
1. For example, if FBE method is used in this case, it can be assumed that sensing results of sidelink resource preemption and/or channel from the UE 1 and the UE 2 are the same. For example, if the UE 1 determines that the sidelink resource channel is busy, the UE 2 may also determine that the sidelink resource is busy, so the UE 2 can send the state information.
2. In a case, the second control information is NACK.
3. In a case, the second control information indicates that preemption and/or channel access of the sidelink resource corresponding to the PSFCH fails.

Further, SL HARQ-ACK corresponding to the PSCCH and/or PSSCH is also indicated.

The advantage of this is that the UE 2 directly informs the PSCCH and/or PSSCH whether the decoding is successful or not, and does not preempt the PSFCH resource. In a case of successful decoding, the base station may not need to schedule retransmission.

### Example 4: It is Extended to be Used Between Two Mode 2 UEs

1. The UE 3 explicitly or implicitly indicates the sidelink resource of the UE 1.
a. Indicate information through at least one of the PSCCH, the SCI, the PSFCH, the preamble, and the like.

For example, the SCI indicates the PSSCH resource, and the UE 2 needs to perform transmission or reception on the PSSCH indicated by the SCI sent by the UE 1, but before that, it needs to be sensed whether the resource is idle and available (that is, the UE 1 sends 1st-similar SCI to preempt a channel and reserve a resource, and the UE 2 actually performs transmission or reception on the PSSCH based on SCI indication after receiving it).
b. The implicit indication may indicate that there is a correspondence between the information and the sidelink resource.

For example, there is a correspondence between the PSFCH resource and the PSSCH resource, and the UE 2 needs to perform transmission or reception on the PSSCH resource corresponding to the PSFCH sent by the UE 1, but before that, it needs to be sensed whether the resource is idle and available.
2. The UE 1 performs sensing and/or transmission based on the indication information.
3. In some implementations, the UE 1 and/or the UE 2 send/sends the state information to the UE 3.

### Example 5

Case 1. For Transport Block (TB) transmission based on HARQ, if feedback is made by using the ACK-NACK-based method. The ACK-NACK-based method refers to that ACK is fed back when decoding is successful, and NACK is fed back when decoding fails. Then, if the UE cannot use part or all of the allocated resource or the sidelink resource due to Clear Channel Assessment (CCA) or eCCA failure, the state information is determined as NACK.

Case 2. For TB transmission based on HARQ, if feedback is made by using the NACK-only-based method. The NACK-only-based method refers to no feedback when decoding is successful, and NACK is fed back when decoding fails. Then, if the UE cannot use part or all of the allocated resource or the sidelink resource due to CCA or eCCA failure, the state information is determined as NACK.

In this embodiment of this application, by determining the state information corresponding to the sidelink resource of the unlicensed frequency band and sending the state information, the control node and the terminal are guaranteed to understand the same, and the resource utilization rate is improved.

FIG. 4 is a first schematic diagram of a structure of an information transmission apparatus according to an embodiment of this application. As shown in FIG. 4, an embodiment of this application provides an information transmission apparatus, including:
a first determining module 401, configured to determine state information corresponding to a sidelink resource on an unlicensed frequency band; and
a first indication module 402, configured to send the state information to a target node, where the target node includes a control node and/or a target terminal.

In some implementations, the following is further included:
a first obtaining module, configured to: obtain first indication information, where the first indication information is used to indicate at least one of the following:
the sidelink resource; and
a listening parameter of the sidelink resource; and
sense the sidelink resource.

In some implementations, the following is further included:
a second obtaining module, configured to obtain a state information configuration, where
the state information configuration includes at least one of the following:
information about a reporting resource for indicating state information;
a state information reporting manner; and
state information content.

The information transmission apparatus in this embodiment of this application may be an apparatus or an apparatus or electronic device with an operating system, or may be a component, an integrated circuit, or a chip in a terminal. The apparatus or electronic device may be a mobile terminal, or a non-mobile terminal. For example, the mobile terminal may include but is not limited to the foregoing listed types of terminals 11. The non-mobile terminal may be a server, a Network Attached Storage (NAS), a personal computer, a television, a teller machine, or a self-service machine. This is not specifically limited in this embodiment of this application.

The information transmission apparatus provided in this embodiment of this application can implement the processes implemented in the method embodiment in FIG. 2, and achieve a same technical effect. To avoid repetition, details are not described herein again.

FIG. 5 is a second schematic diagram of a structure of an information transmission apparatus according to an embodiment of this application. As shown in FIG. 5, an embodiment of this application provides an information transmission apparatus, including:
a third obtaining module 501, configured to obtain state information, where the state information is sent to the target node after a terminal determines state information corresponding to a sidelink resource on an unlicensed frequency band; and the target node includes a control node and/or a target terminal.

In some implementations, the following is further included:
a first sending module, configured to: send first indication information, where
the first indication information is used to indicate at least one of the following:
the sidelink resource; and
a listening parameter of the sidelink resource; and
sense the sidelink resource.

In some implementations, the following is further included:
a second sending module, configured to send a state information configuration, where
the state information configuration includes at least one of the following:
information about a reporting resource for indicating state information;
a state information reporting manner; and
state information content.

In some implementations, a second determining module is further included;
in a case that the state information includes first state information, the second determining module is configured to determine at least one of the following:
at least part of a first sidelink resource is available;
at least part of a first sidelink resource is idle;
at least part of the first sidelink resource is available to another terminal;
at least part of the first sidelink resource is idle for another terminal; and transmission or reception performed on at least part of the first sidelink resource is successful, where
the first state information is state information corresponding to the first sidelink resource; and the first sidelink resource is at least part of the sidelink resource.

In some implementations, a third determining module is further included; and
in a case that the state information includes second state information, the third determining module is configured to determine at least one of the following:
at least part of a second sidelink resource is unavailable;
at least part of a second sidelink resource is busy;
at least part of the second sidelink resource is unavailable to another terminal;
at least part of the second sidelink resource is busy for another terminal;
at least part of the second sidelink resource is not used for transmission or reception; and
transmission or reception performed on at least part of the second sidelink resource fails.

In some implementations, a second indication module is further included; and
after the second state information, the second indication module is configured to indicate a third sidelink resource to a first terminal.

In some implementations, a third indication module is further included; and
before a reporting resource of the second state information, the third indication module is configured to indicate a third sidelink resource to a first terminal.

The information transmission apparatus in this embodiment of this application may be an apparatus or an apparatus or electronic device with an operating system, or may be a component, an integrated circuit, or a chip in a terminal. The apparatus or electronic device may be a mobile terminal, or a non-mobile terminal. For example, the mobile terminal may include but is not limited to the foregoing listed types of terminals 11. The non-mobile terminal may be a server, an NAS, a personal computer, a television, a teller machine, or a self-service machine. This is not specifically limited in this embodiment of this application.

The information transmission apparatus provided in this embodiment of this application can implement the processes implemented in the method embodiment in FIG. 3, and achieve a same technical effect. To avoid repetition, details are not described herein again.

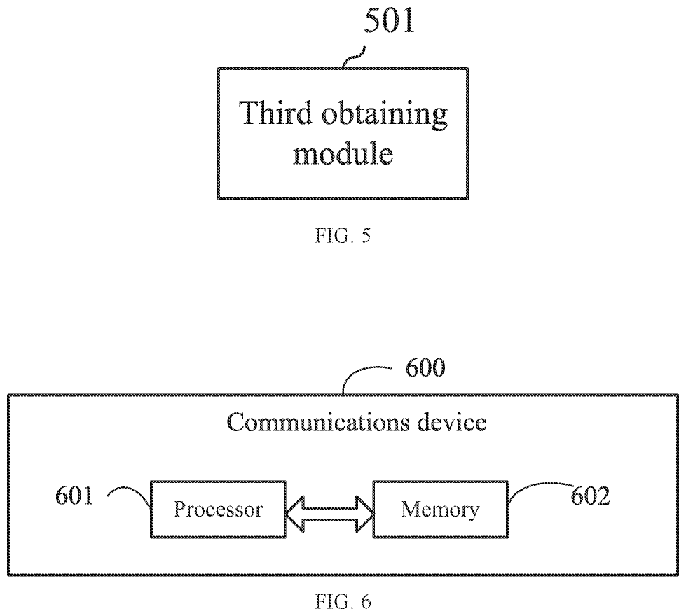

FIG. 6 is a schematic diagram of a structure of a communications device according to an embodiment of this application. As shown in FIG. 6, this embodiment of this application further provides a communications device 600, including a processor 601, a memory 602, a program or an instruction stored in the memory 602 and executable on the processor 601. For example, when the communications device 600 is a terminal, the program or the instruction is executed by the processor 601 to implement the processes of the information transmission method embodiment, and a same technical effect can be achieved. When the communications device 600 is a network side device, the program or the instruction is executed by the processor 601 to implement the processes of the foregoing information transmission method embodiment, and a same technical effect can be achieved. To avoid repetition, details are not described herein again.

An embodiment of this application further provides a terminal, including a processor and a communications interface, where the processor is configured to: determine state information corresponding to a sidelink resource on an unlicensed frequency band; and send the state information to the target node, where the target node includes a control node and/or a target terminal. The terminal embodiment is corresponding to the method embodiment which is performed by the terminal, each implementation process and implementation of the method embodiment can be applied to the terminal embodiment, and a same technical effect can be achieved.

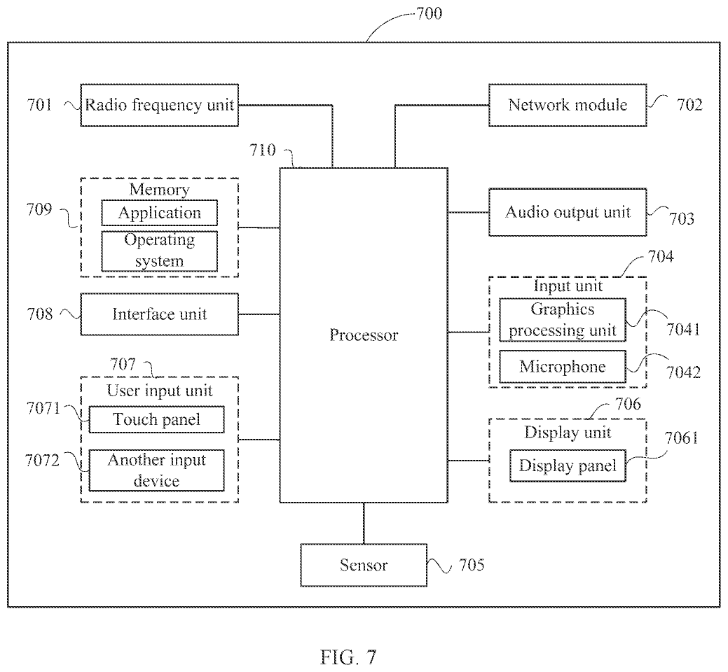

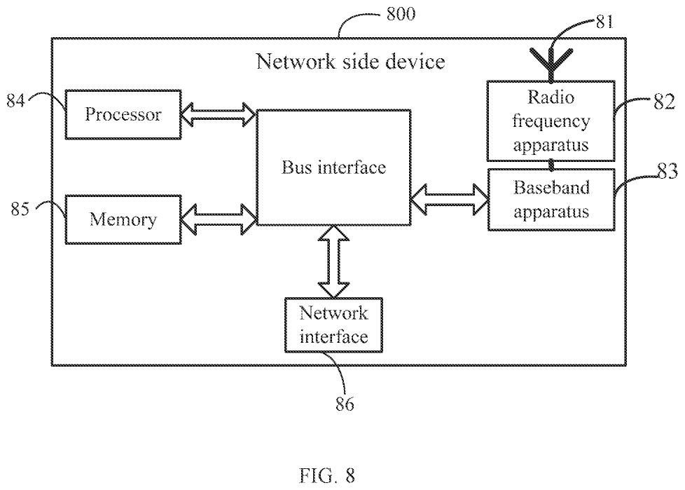

In some implementations, FIG. 7 is a schematic diagram of a hardware structure of a terminal according to an embodiment of this application. As shown in FIG. 7, the terminal 700 includes but is not limited to at least part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in the embodiments of this application, the input unit 704 may include a Graphics Processing Unit (GPU) 7041 and a microphone 7042, and the graphics processing unit 7041 processes image data of a still picture or video obtained by an image capture apparatus (such as a camera) in a video capture mode or an image capture mode. The display unit 706 may include a display panel 7061. In some implementations, the display panel 7061 may be configured in a form such as a liquid crystal display or an organic light-emitting diode. The user input unit 707 includes a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, the radio frequency unit 701 receives downlink data from a network side device and then sends the downlink data to the processor 710 for processing; and sends uplink data to the network side device. Usually, the radio frequency unit 701 includes but is not limited to an antenna, at least one amplifier, a transceiver, a coupler, a low noise amplifier, a duplexer, and the like.

The memory 709 may be configured to store a software program or an instruction and various data. The memory 709 may mainly include a program or instruction storage area and a data storage area. The program or instruction storage area may store an operating system, and an application or an instruction required by at least one function (for example, a sound playing function or an image playing function). In addition, the memory 709 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 710 may include one or more processing units. In some implementations, an application processor and a modem processor may be integrated into the processor 710. The application processor mainly processes an operating system, a user interface, an application, an instruction, or the like. The modem processor mainly processes wireless communication, for example, a baseband processor. It can be understood that, in some implementations, the modem processor may not be integrated into the processor 710.

The processor 710 is configured to determine state information corresponding to a sidelink resource on an unlicensed frequency band; and
the processor 710 is further configured to send the state information to a target node, where the target node includes a control node and/or a target terminal.

In some implementations, the following is further included:
obtaining first indication information, where
the first indication information is used to indicate at least one of the following:
the sidelink resource; and
a listening parameter of the sidelink resource; and
sensing the sidelink resource.

In some implementations, the state information includes at least one of the following.
first state information corresponding to a first sidelink resource, where the first sidelink resource is at least part of the sidelink resource; and
second state information corresponding to a second sidelink resource, where the second sidelink resource is at least part of the sidelink resource.

In some implementations, the first state information is used to indicate at least one of the following:
the first sidelink resource is available;
the first sidelink resource is idle;
the first sidelink resource is available to another terminal;
the first sidelink resource is idle for another terminal;
transmission or reception on the first sidelink resource is successful; ACK;
feedback information; and
an SL decoding state.

In some implementations, the second state information is used to indicate at least one of the following:
the second sidelink resource is unavailable;
the second sidelink resource is busy;
the second sidelink resource is unavailable to another terminal;
the second sidelink resource is busy for another terminal;
transmission or reception on the second sidelink resource fails;
did not detect the transmission or reception of the second sidelink resource;
no feedback corresponding to transmission or reception on the second sidelink resource is detected;
transmission or reception on the second sidelink resource is canceled;
a feedback corresponding to transmission or reception on the second sidelink resource is canceled;
NACK;
feedback information; and
an SL decoding state.

In some implementations, the second sidelink resource meets at least one of the following conditions:
each second sidelink resource has at least one associated resource for indicating the second state information;
an N1^{th} second sidelink resource of the second sidelink resource or an M1^{th} second sidelink resource of at least part of the second sidelink resource has at least one associated resource for indicating the second state information; and
N2 second sidelink resources of the second sidelink resource or M2 second sidelink resources of at least part of the second sidelink resource has at least one associated preamble resource for indicating the second sidelink resource, where N1, N2, M1, and M2 are all positive integers.

In some implementations, a step of indicating the state information to another node includes:
sending the first state information to the control node, where the sending the first state information to the control node includes at least one of the following:
sending the first state information;
not sending state information; and
not sending the second state information.

In some implementations, a step of indicating the state information to another node includes:
sending the second state information to the control node, where the sending the second state information to the control node includes at least one of the following:
sending the second state information;
not sending state information; and
not sending the first state information.

In some implementations, a step of sending, by the terminal, the state information to a target node includes:
sending the first state information to the control node under a first preset condition, where the first preset condition includes at least one of the following:
at least part of the sidelink resource is available;
at least part of the sidelink resource is idle;
at least part of the sidelink resource is available to another terminal;
at least part of the sidelink resource is idle for another terminal;
transmission or reception is performed on at least part of the sidelink resource; and
transmission or reception performed on at least part of the sidelink resource is successful.

In some implementations, a step of sending, by the terminal, the state information to a target node includes:
sending the second state information to the control node in a second preset condition, where the second preset condition includes at least one of the following:
at least part of the sidelink resource is unavailable;
at least part of the sidelink resource is busy;
at least part of the sidelink resource is unavailable to another terminal;
at least part of the sidelink resource is busy for another terminal;
at least part of the sidelink resource is not used for transmission or reception;
transmission or reception performed on at least part of the sidelink resource fails:
a first terminal does not receive an expected feedback; and
a feedback received by the first terminal is NACK.

In some implementations, the state information includes at least one of the following:
state information corresponding to any or all types of sidelink resources; and
state information corresponding to each of different types of sidelink resources.

In some implementations, a step of sending, by the terminal, the state information to a target node includes:
sending the state information to the control node when it is determined that at least one of the following conditions is met:
the control node configures a semi-static resource for the transmission of the state information;
the control node schedules a first terminal to transmit the state information;
at least part of the sidelink resource is available;
at least part of the sidelink resource is idle;
at least part of the sidelink resource is available to another terminal;
at least part of the sidelink resource is idle for another terminal;
transmission or reception is performed on at least part of the sidelink resource;
transmission or reception performed on at least part of the sidelink resource is successful;
ACK is obtained;
transmission or reception on at least part of the sidelink resource is decoded successfully;
feedback information corresponding to transmission or reception on at least part of the sidelink resource is ACK; and
the state information includes first state information.

In some implementations, the following is further included:
obtaining a state information configuration, where
the state information configuration includes at least one of the following:
information about a reporting resource for indicating state information;
a state information reporting manner; and
state information content.

In some implementations, a step of sending, by the terminal, the state information to another control node includes:
sending, by the terminal, the state information to another control node through a reporting resource, where
the reporting resource meets at least one of the following:
different types of state information are corresponding to different reporting resources;
pieces of state information with different content are corresponding to different reporting resources;
pieces of state information corresponding to different sidelink resources are corresponding to different reporting resources; and
pieces of state information corresponding to different types of sidelink resources are corresponding to different reporting resources.

In this embodiment of this application, by determining the state information corresponding to the sidelink resource of the unlicensed frequency band and sending the state information, the control node and the terminal are guaranteed to understand the same, and the resource utilization rate is improved.

An embodiment of this application further provides a network side device, including a processor and a communications interface, where the processor is configured to obtain state information, and the state information is state information corresponding to the sidelink resource determined by the user equipment after sensing the sidelink resource of the unlicensed frequency band. This network side device embodiment is corresponding to the method embodiment performed by a target node. Each implementation process and implementation of the foregoing method embodiment may be applicable to this network side device embodiment, and a same technical effect can be achieved.

In some implementations, FIG. 8 is a schematic diagram of a hardware structure of a network side device according to an embodiment of this application. As shown in FIG. 8, an embodiment of this application further provides a network side device, and the network side device 800 includes: an antenna 81, a radio frequency apparatus 82, and a baseband apparatus 83. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

The frequency band processing apparatus may be located in the baseband apparatus 83. The method performed by the network side device in the foregoing embodiment may be implemented in the baseband apparatus 83. The baseband apparatus 83 includes a processor 84 and a memory 85.

The baseband apparatus 83 may include, for example, at least one baseband board, where a plurality of chips are disposed on the baseband board. As shown in FIG. 8, one chip is, for example, the processor 84, which is connected to the memory 85, so as to invoke a program in the memory 85 to perform operations of the network device shown in the foregoing method embodiment.

The baseband apparatus 83 may further include a network interface 86, configured to exchange information with the radio frequency apparatus 82. For example, the interface is a Common Public Radio Interface (CPRI for short).

The network side device in this embodiment of the present invention further includes an instruction or a program stored in the memory 85 and executable on the processor 84. The processor 84 invokes the instruction or the program in the memory 85 to perform the method performed by the modules shown in FIG. 5, and a same technical effect is achieved. To avoid repetition, details are not described herein again.

An embodiment of this application further provides a readable storage medium. The readable storage medium stores a program or an instruction, and when the program or the instruction is executed by a processor, the processes of the foregoing information transmission method embodiment are implemented and a same technical effect can be achieved. To avoid repetition, details are not described herein again.

The processor is a processor in the terminal in the foregoing embodiment. The readable storage medium includes a computer-readable storage medium such as a Read-Only Memory (ROM), a Random Access Memory (RAM), a magnetic disk, an optical disc, or the like.

An embodiment of this application further provides a chip. The chip includes a processor and a communications interface, the communications interface is coupled to the processor, and the processor is configured to run a program or an instruction to implement processes of the embodiment of the information transmission method, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the term “include,” “comprise,” or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air-conditioner, a network device, or the like) to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. An information transmission method, comprising:
determining, by a terminal, state information corresponding to a SideLink (SL) resource on an unlicensed frequency band; and
sending, by the terminal, the state information to a target node, wherein the target node comprises a control node or a target terminal.

2. The information transmission method according to claim 1, wherein the state information comprises at least one of the following:
first state information corresponding to a first SL resource, wherein the first SL resource is at least part of the SL resource; or
second state information corresponding to a second SL resource, wherein the second SL resource is at least part of the SL resource.

3. The information transmission method according to claim 2, wherein the first state information is used to indicate at least one of the following:
the first SL resource is available;
the first SL resource is idle;
the first SL resource is available to another terminal;
the first SL resource is idle for another terminal;
transmission or reception on the first SL resource is successful;
ACKnowledgement (ACK);
feedback information; or
an SL decoding state.

4. The information transmission method according to claim 2, wherein the second state information is used to indicate Negative ACKnowledgement (NACK).

5. The information transmission method according to claim 4, wherein determining, by a terminal, state information corresponding to a SideLink (SL) resource on an unlicensed frequency band comprises:
determining, by a terminal, state information corresponding to the second SL resource on an unlicensed frequency band is NACK, if the terminal fails in channel access.

6. The information transmission method according to claim 5, wherein determining, by a terminal, state information corresponding to the second SL resource on an unlicensed frequency band is NACK, if the terminal fails in channel access comprises:
determining, by a terminal, state information corresponding to the second SL resource on an unlicensed frequency band is NACK, if the terminal cannot use all of the second SL resource due to the terminal fails in channel access.

7. The information transmission method according to claim 2, wherein sending the state information to a target node comprises:
sending the first state information to the control node under a first preset condition, wherein the first preset condition comprises at least one of the following:
at least part of the SL resource is available;
at least part of the SL resource is idle;
at least part of the SL resource is available to another terminal;
at least part of the SL resource is idle for another terminal;
transmission or reception is performed on at least part of the SL resource; or
transmission or reception performed on at least part of the SL resource is successful.

8. The information transmission method according to claim 1, wherein the state information comprises at least one of the following:
state information corresponding to any or all types of SL resources; or
state information corresponding to each of different types of SL resources.

9. The information transmission method according to claim 1, wherein sending the state information to a target node comprises:
sending the state information to the control node when it is determined that at least one of the following conditions is met:
the control node configures a semi-static resource for the transmission of the state information;
the control node schedules a first terminal to transmit the state information;
at least part of the SL resource is available;
at least part of the SL resource is idle;
at least part of the SL resource is available to another terminal;
at least part of the SL resource is idle for another terminal;
transmission or reception is performed on at least part of the SL resource;
transmission or reception performed on at least part of the SL resource is successful;
ACKnowledgement (ACK) is obtained;
transmission or reception on at least part of the SL resource is decoded successfully;
feedback information corresponding to transmission or reception on at least part of the SL resource is ACK; or
the state information comprises first state information.

10. The information transmission method according to claim 1, further comprising:
obtaining a state information configuration, wherein the state information configuration comprises at least one of the following:
information about a reporting resource for indicating state information;
a state information reporting manner; or
state information content.

11. The information transmission method according to claim 1, wherein sending the state information to another control node comprises:
sending, by the terminal, the state information to another control node through a reporting resource, wherein the reporting resource meets at least one of the following:
different types of state information are corresponding to different reporting resources;
pieces of state information with different content are corresponding to different reporting resources;
pieces of state information corresponding to different SL resources are corresponding to different reporting resources; or
pieces of state information corresponding to different types of SL resources are corresponding to different reporting resources.

12. An information transmission method, comprising:
obtaining, by a target node, state information, wherein the state information is sent to the target node after a terminal determines state information corresponding to a SideLink (SL) resource on an unlicensed frequency band, and the target node comprises a control node or a target terminal.

13. The information transmission method according to claim 12, further comprising:
sending first indication information, wherein the first indication information is used to indicate at least one of the following:
the SL resource; or
a listening parameter of the SL resource; and
sensing the SL resource.

14. The information transmission method according to claim 12, further comprising:
sending a state information configuration, wherein the state information configuration comprises at least one of the following:
information about a reporting resource for indicating state information;
a state information reporting manner; or
state information content.

15. The information transmission method according to claim 12, wherein when the state information comprises first state information, at least one of the following is determined:
at least part of a first SL resource is available;
at least part of a first SL resource is idle;
at least part of the first SL resource is available to another terminal;
at least part of the first SL resource is idle for another terminal; or
transmission or reception performed on at least part of the first SL resource is successful, wherein the first state information is state information corresponding to the first SL resource, and the first SL resource is at least part of the SL resource.

16. The information transmission method according to claim 12, wherein when the state information comprises second state information, at least one of the following is determined:
at least part of a second SL resource is unavailable;
at least part of a second SL resource is busy;
at least part of the second SL resource is unavailable to another terminal;
at least part of the second SL resource is busy for another terminal;
at least part of the second SL resource is not used for transmission or reception; or
transmission or reception performed on at least part of the second SL resource fails.

17. The information transmission method according to claim 16, further comprising:
after the second state information, scheduling a third SL resource to a first terminal,
or,
before a reporting resource of the second state information, scheduling a third SL resource to a first terminal.

18. A terminal, comprising:
a memory storing computer-readable instructions; and
a processor coupled to the memory and configured to execute the computer-readable instructions, wherein the computer-readable instructions, when executed by the processor, cause the processor to perform operations comprising:
determining state information corresponding to a SideLink (SL) resource on an unlicensed frequency band; and
sending the state information to a target node, wherein the target node comprises a control node or a target terminal.

19. The terminal according to claim 18, wherein the state information comprises at least one of the following:
first state information corresponding to a first SL resource, wherein the first SL resource is at least part of the SL resource; or
second state information corresponding to a second SL resource, wherein the second SL resource is at least part of the SL resource.

20. The terminal according to claim 19, wherein the second state information is used to indicate Negative ACKnowledgement (NACK).
